(19) United States
(12) Patent Application Publication
(10) Pub. No.: US 2026/0105638 A1
(43) Pub. Date: Apr. 16, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Chiaki KANEKO, Kanagawa (JP)

(21) Appl. No.: 19/350,251

(22) Filed: Oct. 6, 2025

(30) Foreign Application Priority Data
Oct. 10, 2024 (JP) 2024-177813

(51) Int. Cl. G06T 7/90; G06T 7/00; G06T 7/80; G06T 11/00

(52) U.S. Cl. CPC G06T 7/90; G06T 7/80; G06T 7/97; G06T 11/10; G06T 2207/10024; G06T 2207/20081

(57) ABSTRACT

Spatial information is estimated with high accuracy. An information processing apparatus according to the present disclosure obtains captured images obtained by image capturing on an object from multiple viewpoints and camera parameters corresponding to each of the viewpoints in the image capturing, obtains information indicating a transmissive region in each of the captured images, sets background colors different from one another, generates training images corresponding to each of the background colors based on the captured images and the transmissive region, and learns spatial information based on differences between color values of synthesized colors and color values of the training image corresponding to each background color of the plurality of background colors. The synthesized colors are each obtained by synthesizing, for each of the background colors, an accumulated color and the background color. The accumulated color is obtained by accumulating pieces of the spatial information based on the camera parameters.

### BACKGROUND

### Field of the Technology

The present disclosure relates to an information processing technique for modeling a target space.

### Description of the Related Art

There is a technique of estimating spatial information about an object that is present in a target space, based on a plurality of captured images obtained by image capturing from a plurality of viewpoints (hereinafter referred to as “multi-viewpoint images”). Here, the spatial information includes, for example, radiance fields that represent the volume densities of the object for positions in a space and colors for directions. By using estimated radiance fields, an image corresponding to the appearance of the object as viewed from a given virtual viewpoint (hereinafter referred to as a “virtual viewpoint”) can be generated (hereinafter referred to as a “virtual viewpoint image”). In the following description, a target space for estimating the radiance fields will be referred to as a “scene.”

Japanese Translation of PCT International Application Publication No. 2023-543538 (hereinafter referred to as “Patent Literature 1”) discloses a technique in which radiance fields are estimated through deep learning with multi-viewpoint images used as ground truths, and pixel values of a virtual viewpoint image are calculated by integrating colors along rays originating from a given viewpoint based on the estimated radiance fields. Such a process of calculating pixel values is generally referred to as volume rendering. In the deep learning disclosed in Patent Literature 1, the volume rendering is first performed to generate virtual viewpoint images as the virtual viewpoints of which are the same as viewpoints from which captured images are captured (hereinafter referred to as “image capturing viewpoints”). Then, the deep learning is performed using the differences between the pixel values of the generated virtual viewpoint images and the pixel values of the captured images as a loss.

### SUMMARY

The technique disclosed in Patent Literature 1 described above (hereinafter referred to as the “related art”) is originally a technique of collectively learning the entire space as a target of image capturing. Thus, the deep learning is performed on a space including not only a target object but also the background of the object and the other objects. Here, the inventor found the following. In a case where the number of parameters representing radiance fields and the number of rays for sampling a space are unchanged, the accuracy of the virtual viewpoint images generated by the related art decreases with an increase in the size of a space as a target to be learned (hereinafter referred to as a “region to be learned”). On the other hand, processing time and memory capacity required to learn the radiance fields increase with increases in the number of parameters and the number of rays. Accordingly, it is desirable that the region to be learned is confined within the smallest possible space containing a target object that is intended to be reproduced on a virtual, viewpoint image as a representation.

An information processing apparatus according to the present disclosure includes one or more hardware processors; and one or more memories storing one or more programs configured to be executed by the one or more hardware processors, the one or more programs including instructions for: obtaining a plurality of captured images and camera parameters, the plurality of captured images being obtained by performing image capturing on an object from a plurality of viewpoints, the camera parameters corresponding to each of the plurality of viewpoints in the image capturing; obtaining information indicating a transmissive region in each of the plurality of captured images; setting a plurality of background colors different from one another; generating training images corresponding to each of the plurality of background colors based on the captured images and the transmissive region; and learning the spatial information based on differences between color values of synthesized colors and color values of the training image corresponding to each background color of the plurality of background colors, the synthesized colors each being obtained by synthesizing, for each of the background colors, an accumulated color and the background color, the accumulated color being obtained by accumulating pieces of spatial information based on the camera parameters.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating an example of a hardware configuration of an information processing apparatus according to a first embodiment.

FIG. 2 is a block diagram illustrating an example of a logical configuration of the information processing apparatus according to the first embodiment.

FIG. 3 is a diagram illustrating an example of arrangement of a target object, a background object, a region to be learned, and image capturing devices, according to the first embodiment.

FIGS. 4A to 4C are diagrams each illustrating an example of a captured image according to the first embodiment.

FIG. 5 is a flowchart illustrating an example of a processing flow of the information processing apparatus according to the first embodiment.

FIG. 6 is a diagram illustrating an example of a GUI according to the first embodiment.

FIGS. 7A to 7C are diagrams each illustrating an example of an object region mask according to the first embodiment.

FIGS. 8A to 8F are diagrams each illustrating an example of a training image according to the first embodiment.

FIG. 9 is a diagram illustrating an example of a ray r according to the first embodiment.

FIG. 10A is a diagram illustrating an example of an object represented with erroneous radiance fields, and FIGS. 10B to 10G are diagrams illustrating examples of an estimated image calculated based on the erroneous radiance fields.

FIG. 11 is a diagram illustrating an example of a GUI according to the first embodiment.

### DESCRIPTION OF THE EMBODIMENTS

The present inventor further found the following. In a case where a region to be learned is confined within a small space, a background and other objects, which are other than a target object, are not included in the region to be learned. As a result, in a case where volume rendering is performed to generate a virtual viewpoint image such that its virtual viewpoint is the same viewpoint as an image capturing viewpoint, there may be a ray corresponding to a pixel of the virtual viewpoint image that makes all of points on the ray within the region to be learned have no volume densities or colors. In contrast, a captured image includes the background or the representations of the other objects, which are excluded from the region to be learned. This may produce an inconsistency between spatial information corresponding to the region to be learned and the captured image. As a method for eliminating such an inconsistency, it is conceivable to replace, for each of captured images constituting multi-viewpoint images, the colors of a region in a region to be learned that excludes a target object (hereinafter referred to as a “transmissive region”) with a background color in a virtual space (hereinafter referred to as a “learning background color”) for learning.

However, in the related art, the color of a pixel of the virtual viewpoint image that corresponds to a ray is made equal to the learning background color in both a case where no object is present on the ray and a case where an object with the same color as the learning background color is present on the ray. As a result, there may be no difference in loss in the learning between radiance fields resulting from a transmissive region that is correctly learned and radiance fields resulting from a transmissive region that is erroneously learned as if an object with the same color as the learning background color is present in the transmissive region. That is, in such a case, the learning may converge to erroneous radiance fields, thus causing such a problem that an artifact appears on a virtual viewpoint image in a case where a viewpoint different from the image capturing viewpoint is set as its virtual viewpoint.

The present disclosure provides a technique capable of estimating spatial information corresponding to a region to be learned with high accuracy.

Hereinafter, with reference to the attached drawings, the present invention is explained in detail in accordance with preferred embodiments. Configurations shown in the following embodiments are merely exemplary and the present invention is not limited to the configurations shown schematically.

### First Embodiment

In the present embodiment, there will be described an aspect in which a plurality of learning background colors are set, a training image and a virtual viewpoint image are generated for each of the learning background colors, and a loss in learning is calculated based on the difference between the training image and the virtual viewpoint image in each learning background color.

### <Hardware Configuration of Information Processing Apparatus>

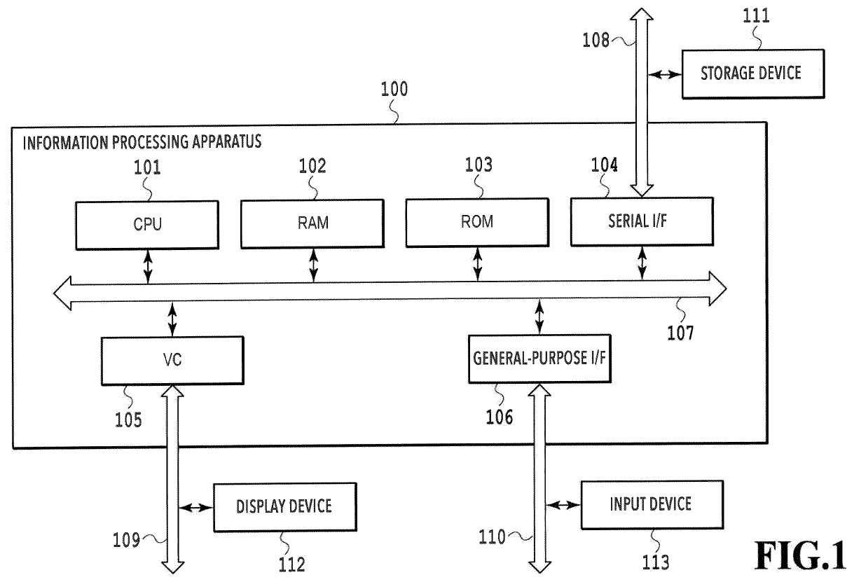

FIG. 1 is a block diagram illustrating an example of a hardware configuration of an information processing apparatus 100 according to a first embodiment. The information processing apparatus 100 includes, as its hardware configuration, a CPU 101, a RAM 102, a ROM 103, a serial interface (I/F) 104, a video card (VC) 105, and a general-purpose 1/F 106. The components included in the information processing apparatus 100 as the hardware configuration are connected via a system bus 107 so as to be capable of communicating with one another. The CPU 101 executes an operating system (OS) and various types of programs stored in the ROM 103, a storage device 111, or the like, using the RAM 102 as a working memory. The CPU 101 controls the entire information processing apparatus 100 via the system bus 107 by executing the various types of programs. Note that the processes of steps illustrated in a flowchart described later are implemented such that a program code stored in the ROM 103, the storage device 111, or the like is loaded onto the RAM 102 and executed by the CPU 101.

The serial I/F 104 is an interface compliant with serial ATA or the like. The information processing apparatus 100 is connected to the storage device 111 via a serial bus 108. The storage device 111 is a large-capacity storage device such as a hard disk drive (HDD) or a solid state drive (SSD). The present embodiment will be described assuming that the storage device 111 is an external apparatus for the information processing apparatus 100. However, the information processing apparatus 100 may include the storage device 111 as an internal device. The VC 105 receives a control signal from the CPU 101 and outputs, via a serial bus 109, a signal about a displayed image to a display device 112. The display device 112 includes a liquid crystal display device or the like. The display device 112 displays the displayed image based on the signal about the displayed image output from the information processing apparatus 100. The general-purpose I/F 106 is connected to an input device 113 such as a mouse or a keyboard via a serial bus 110 and receives an input signal from the input device 113.

The CPU 101 displays a graphical user interface (GUI) provided by the program on the display device 112 via the VC 105 and receives an input signal indicating an instruction from a user obtained via the input device 113. The information processing apparatus 100 is implemented with, for example, a desktop personal computer (PC). The information processing apparatus 100 may be implemented with a laptop PC, a tablet PC, or the like integrated with the display device 112. The storage device 111 may be implemented with a medium (portable storage medium) and a drive such as a disk drive or a reader such as a memory card reader to access the medium. As the medium, a flexible disk (FD), a compact disc read-only memory (CD-ROM), digital versatile disc (DVD), a universal serial bus (USB) memory, a magneto-optical (MO) disc, a flash memory, or the like may be used.

### <Logical Configuration of Information Processing Apparatus>

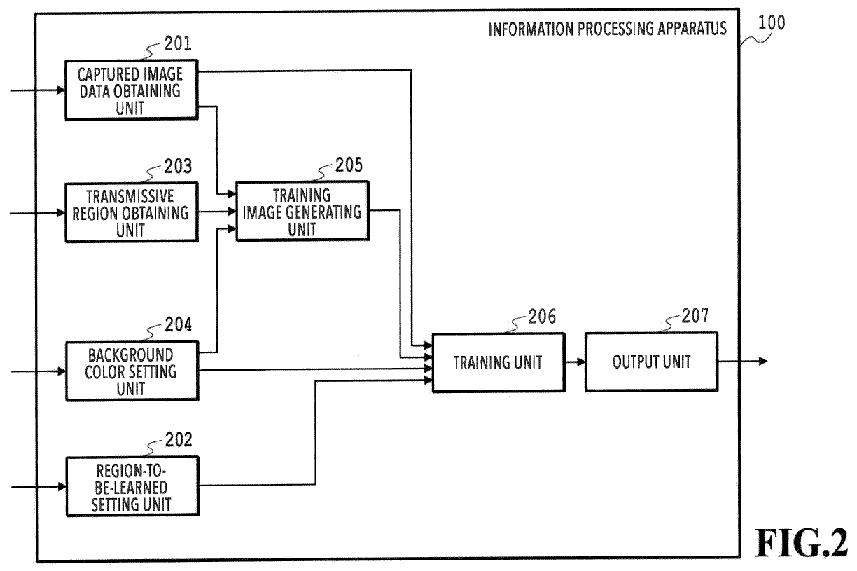

FIG. 2 is a block diagram illustrating a logical configuration of the information processing apparatus 100 according to the first embodiment. As the logical configuration, the information processing apparatus 100 includes a captured image data obtaining unit 201, a region-to-be-learned setting unit 202, a transmissive region obtaining unit 203, a background color setting unit 204, a training image generating unit 205, a training unit 206, and an output unit 207. The units included in the information processing apparatus 100 as the logical configuration are implemented such that the program stored in the ROM 103 or the like is executed by the CPU 101 using the RAM 102 as a working memory. Note that all of the processes described below need not necessarily be executed by the CPU 101. The information processing apparatus 100 may be configured such that some or all of the processes are executed by one or more processing circuits other than the CPU 101.

The captured image data obtaining unit 201 obtains data on a plurality of captured images obtained by performing image capturing on an object present in a scene from different image capturing viewpoints (multi-viewpoint images), based on an instruction from the user input via the input device 113. The following description will be given assuming that the data on the captured images obtained by the captured image data obtaining unit 201 is image data in an RGB image format. The captured image data obtaining unit 201 may obtain the data on the multi-viewpoint images by directly obtaining, from image capturing devices, the data on the captured images output by the image capturing devices or may obtain the data on the multi-viewpoint images by reading, from the storage device 111 or the like, data on captured images that are stored in advance. The obtained data on the multi-viewpoint images is transmitted to the training image generating unit 205.

The captured image data obtaining unit 201 also obtains camera parameters of the image capturing devices that capture the captured images constituting the multi-viewpoint images. The following description will be given assuming that the camera parameters obtained by the captured image data obtaining unit 201 include intrinsic parameters, extrinsic parameters, and distortion parameters of each image capturing device. The intrinsic parameters are parameters indicating the position of a principal point of the image capturing device and the focal length of the lenses of the image capturing device. The extrinsic parameters are parameters indicating the position of the image capturing device and the optical axis direction of the image capturing device, that is, the orientation of the image capturing device. The distortion parameters are parameters representing the distortion of the optical system of the image capturing device including the lenses and the like. The captured image data obtaining unit 201 may obtain the camera parameters retained by the image capturing device by requesting the camera parameters from the image capturing device or may obtain the camera parameters by reading camera parameters that are stored in the storage device 111 or the like in advance. The obtained camera parameters of each image capturing device are transmitted to the training unit 206.

The region-to-be-learned setting unit 202 sets the position and size of a region to be learned based on an instruction from the user input via the input device 113. The region-to-be-learned setting unit 202 may read information indicating the position and size of the region to be learned that are stored in the storage device 111 or the like in advance to set the position and size of the region to be learned indicated by the information. The following description will be given assuming that the shape of the region to be learned is a rectangular parallelepiped constituted by faces perpendicular to the direction of the three coordinate axes that define a three-dimensional space. The information indicating the set position and size of the region to be learned is transmitted to the training unit 206.

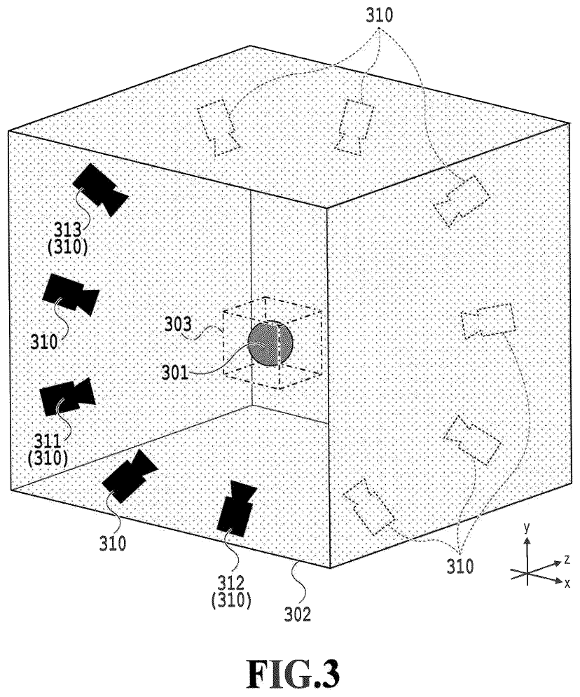

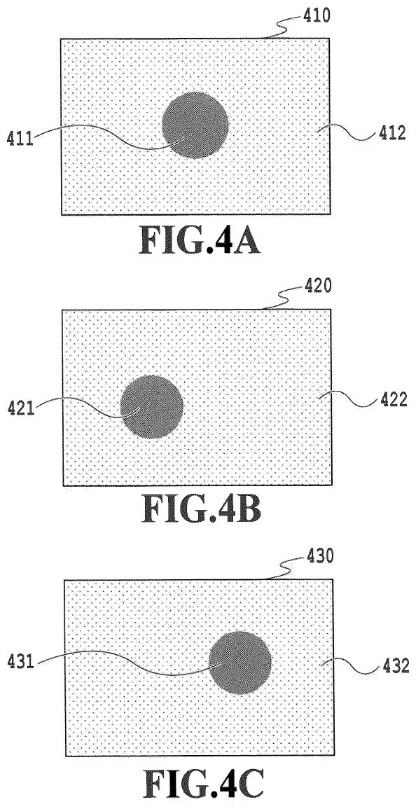

FIG. 3 is a diagram illustrating an example of arrangement of an object 301 that is a target present in a scene, a background object 302, a region to be learned 303, and image capturing devices 310 that capture the objects 301 and 302, according to the first embodiment. FIGS. 4A to 4C are diagrams each illustrating an example of a captured image obtained by image capturing by the image capturing devices 310 according to the first embodiment. Specifically, FIG. 4A illustrates an example of a captured image 410 obtained by image capturing by an image capturing device 311. FIG. 4B illustrates an example of a captured image 420 obtained by image capturing by an image capturing device 312. FIG. 4C illustrates an example of a captured image 430 obtained by image capturing by an image capturing device 313. The captured images 410,420, and 430 include representations 411,421, and 431 of the object 301, which is the target present inside the region to be learned 303, and representations 412, 422, and 432 of the background object 302 that is present outside the region to be learned 303, in this order.

The transmissive region obtaining unit 203 obtains an object region mask that corresponds to each of the captured image constituting the multi-viewpoint images. The object region mask is an image indicating a region corresponding to the representation of the object present inside the region to be learned (hereinafter referred to as an “object region”) in a captured image. The process of obtaining the object region mask by the transmissive region obtaining unit 203 will be described in detail later. Data on the obtained object region mask is transmitted to the training image generating unit 205. The background color setting unit 204 sets a plurality of learning background colors. The process of setting the learning background colors by the background color setting unit 204 will be described in detail later. Information indicating the plurality of set learning background colors is transmitted to the training image generating unit 205 and the training unit 206.

The training image generating unit 205 generates training images to be used for learning described later based on the plurality of captured images that are obtained by the captured image data obtaining unit 201 and constitute the multi-viewpoint images and the object region masks that are obtained by the transmissive region obtaining unit 203 and correspond to the captured images. Specifically, based on the multi-viewpoint images and the object region masks, the training image generating unit 205 generates a training image for each of the captured images constituting the multi-viewpoint images and for each of the learning background colors set by the background color setting unit 204. The process of generating the training images by the training image generating unit 205 will be described in detail later. Data on the generated training images is transmitted to the training unit 206 and the output unit 207.

The training unit 206 estimates spatial information corresponding to the region to be learned set by the region-to-be-learned setting unit 202. The following description will be given assuming that, as an example, the training unit 206 is configured to estimate radiance fields corresponding to the region to be learned as the spatial information corresponding to the region to be learned. Specifically, the training unit 206 estimates the radiance fields corresponding to the region to be learned based on the camera parameters obtained by the captured image data obtaining unit 201, the plurality of learning background colors set by the background color setting unit 204, and the training images generated by the training image generating unit 205. The process of estimating the radiance fields by the training unit 206 will be described in detail later. Information indicating the radiance fields estimated by the training unit 206 is transmitted to the output unit 207 together with the data on training images used in the estimation of the radiance fields and the information indicating the plurality of learning background colors. The output unit 207 outputs the radiance fields estimated by the training unit 206, and the training images used in the estimation of the radiance fields and the information about the plurality of learning background colors to the display device 112, the storage device 111, or the like. The process of the output by the output unit 207 will be described in detail later.

### <Operation of Information Processing Apparatus>

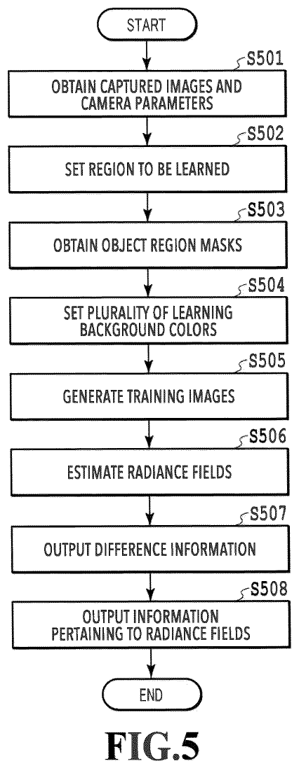

FIG. 5 is a flowchart illustrating an example of a processing flow of the information processing apparatus 100 according to the first embodiment. The processes of the flowchart illustrated in FIG. 5 are implemented by the CPU 101 loading a program stored in the ROM 103 or the like onto the RAM 102 and executing the program. In the following description, the symbol “S” means a step. First, in S501, the captured image data obtaining unit 201 obtains, based on an instruction from the user, the data on the plurality of captured images constituting the multi-viewpoint images and the camera parameters used for capturing the captured images (hereinafter referred to as “camera parameters of the captured images”). Next, in S502, the region-to-be-learned setting unit 202 sets the region to be learned based on an instruction from the user.

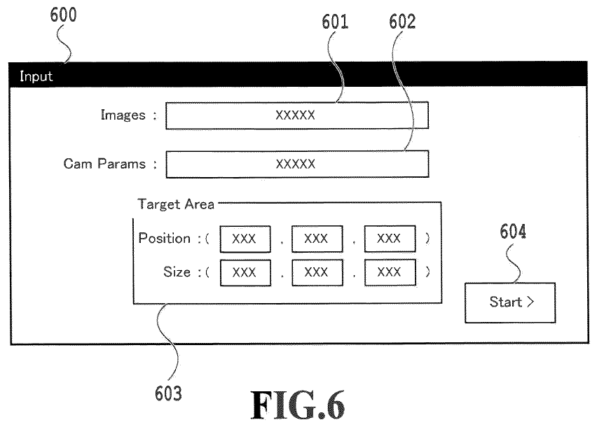

FIG. 6 is a diagram illustrating an example of a GUI 600 that is displayed on the display device 112 according to the first embodiment. The instructions from the user in S501 and S502 are received via the GUI 600 illustrated in FIG. 6 as an example. The GUI 600 includes data path setting fields 601 and 602, a region-to-be-learned setting field 603, and a button 604. The data path setting field 601 is a field into which the user inputs the data path of the data on the multi-viewpoint images. The data path setting field 602 is a field into which the user inputs the data path of the camera parameters of the captured images.

The region-to-be-learned setting field 603 is a field into which the user inputs the coordinates corresponding to the center position of the region to be learned and the lengths of borders in the coordinate axis directions of a rectangular parallelepiped that is set as the region to be learned. The following description will be given assuming that the user has grasped in advance approximate position and size of the object in the scene. Note that the position and size of the object in the scene may be estimated by the region-to-be-learned setting unit 202 or the like based on the multi-viewpoint images, and the region-to-be-learned setting unit 202 may set the position and size of the region to be learned in accordance with the result of the estimation. In this case, to estimate the position and size of the object, a volume intersection method or a stereo matching method may be used. The button 604 is a button that is pressed to issue an instruction to execute the processes by the information processing apparatus 100. In a case where the button 604 is pressed by the user, the processes of S501 and S502 are executed.

After S502, in S503, the transmissive region obtaining unit 203 obtains an object region mask corresponding to each of the captured images obtained in S501. Specifically, the transmissive region obtaining unit 203 first obtains, for each captured image, a difference image indicating the difference between the captured image and a background image. The background image is, for example, an image that is prepared by, for example, performing image capturing in advance on a scene in which no object is present in the region to be learned. Data on the background image is read and obtained from the storage device 111 or the like based on an instruction from the user. The transmissive region obtaining unit 203 then extracts, as the object region, a region in the difference image including pixels the pixel values of which are greater than or equal to a predetermined threshold value. The transmissive region obtaining unit 203 then generates, for example, an image in which the values of pixels (pixel values) included in the object region are set to 1, and the values of pixels (pixel values) outside the object region are set to 0, and obtains the generated image as the object region mask.

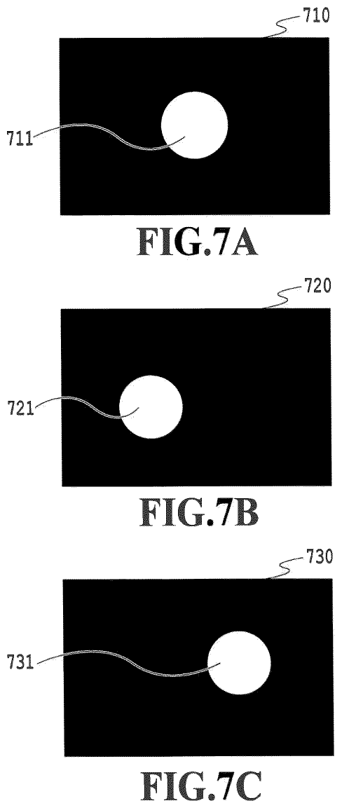

FIGS. 7A to 7C are diagrams each illustrating an example of an object region mask according to the first embodiment. Specifically, FIG. 7A illustrates an example of an object region mask 710 that corresponds to the captured image 410 illustrated in FIG. 4A. FIG. 7B illustrates an example of an object region mask 720 that corresponds to the captured image 420 illustrated in FIG. 4B. FIG. 7C illustrates an example of an object region mask 730 that corresponds to the captured image 430 illustrated in FIG. 4C. In each of the object region masks 710, 720, and 730 illustrated in FIG. 7, the pixels of the object region, which have a pixel value of 1, are illustrated in white, and the pixels outside the object region, which have a pixel value of 0, are illustrated in black. Object regions 711, 721, and 731 in the object region masks 710, 720, and 730 correspond to regions of the representations 411, 421, and 431 of the object 301 present in the region to be learned in the captured images 410, 420, and 430, respectively. Note that the transmissive region obtaining unit 203 may obtain the data on the object region masks that are generated and prepared in advance by reading the data from the storage device 111 or the like based on an instruction from the user.

After S503, in S504, the background color setting unit 204 sets, as the learning background colors, a plurality of colors that are as far from one another as possible in a predetermined color space such as an RGB space. In the following description, it is assumed that the background color setting unit 204 sets K (K≥2) learning background colors, and the k-th learning background color of the K (K≥2) learning background colors will be referred to as a “background color k.” In addition, in the following description, it is assumed that the background color setting unit 204 sets two learning background colors, as an example, and it is assumed that white is set as a background color 1, and black is set as a background color 2, so as to maximize the distance between the two colors in the RGB space.

Next, in S505, the training image generating unit 205 generates the training images based on the multi-viewpoint images obtained in S501, the object region masks that are obtained in S503 and correspond to the captured images constituting the multi-viewpoint images, and the plurality of learning background colors set in S504. Specifically, the training image generating unit 205 generates the training images by replacing colors of image regions in the captured images corresponding to a transmissive region with the learning background colors based on the object region masks corresponding to the captured images constituting the multi-viewpoint images and the plurality of learning background colors. More specifically, the training image generating unit 205 determines an RGB value c_{GTk} (n, u, v) of each pixel of a training image corresponding to a captured image obtained by image capturing by the n-th image capturing device 310 (hereinafter referred to as the “n-th captured image”) using, for example, Equation (1).

$${C}_{GTk} ( n , u , v ) = M ( n , u , v ) {c}_{1} ( n , u , v ) + ( 1 - M ( n , u , v ) ) {c}_{GBk} \qquad Equation ( 1 )$$

Here, u and v are indices indicating the position of a pixel of the image, and M (n, u, v) is the pixel value of a pixel at the position (u, v) of an object region mask corresponding to the n-th captured image. In addition, c_{I}(n, u, v) indicates the RGB value of a pixel at the position (u, v) in then-th captured image, and c_{BGk} indicates the RGB value of a background color k. In the following description, a training image generated using a background color k will be referred to as a “training image for the background color k.” The color of each pixel of the training image for the background color k obtained from Equation (1) is the same as the color of the pixel of the captured image in an image region corresponding to an object region and is the same as the background color k in an image region corresponding to the transmissive region.

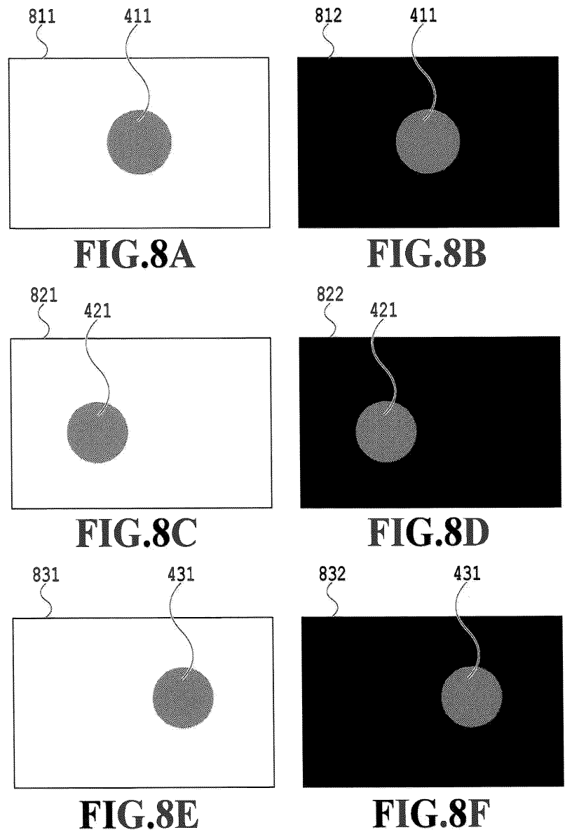

FIGS. 8A to 8F are diagrams each illustrating an example of a training image according to the first embodiment. Specifically, FIG. 8A illustrates an example of a training image 811 for the background color 1 corresponding to the captured image 410 in FIG. 4A. FIG. 8B illustrates an example of a training image 812 for the background color 2 corresponding to the captured image 410 in FIG. 4A. FIG. 8C illustrates an example of a training image 821 for the background color 1 corresponding to the captured image 420 in FIG. 4B. FIG. 8D illustrates an example of a training image 822 for the background color 2 corresponding to the captured image 420 in FIG. 4B. FIG. 8E illustrates an example of a training image 831 for the background color 1 corresponding to the captured image 430 in FIG. 4C. FIG. 8F illustrates an example of a training image 832 for the background color 2 corresponding to the captured image 430 in FIG. 4C.

After S505, in S506, the training unit 206 estimates the radiance fields using the plurality of learning background colors set in S504 for the region to be learned set in S502, based on the camera parameters obtained in S501 and the training images generated in S505. In the following description, it is assumed that the training unit 206 estimates radiance fields that are modeled using the function Fe shown as Equation (2) as an example.

$${F}_{θ} : ( x , y , z , θ , φ ) \to ( c , σ ) \qquad Equation ( 2 )$$

Here, (x, y, z) denote coordinates indicating a position in a space, (θ, φ) denote a direction in the space, c denotes a color determined from the position and direction, and α denotes a volume density determined from the position. The function F_{θ} formalized with Equation (2) is a model that outputs a color and a volume density from the position and direction in the space.

In the following description, as an example, it is assumed that the function Fe is a model implemented in a form of a multi-layer perceptron (MLP), and that the training unit 206 estimates the radiance fields by performing machine learning on the model. In this case, the radiance fields are represented as parameters of the MLP, that is, weight coefficients for nodes constituting the MLP. The estimated parameters of the MLP are stored in a memory area secured in the RAM 102 or the like. Note that the function F_{θ} is not limited to a function implemented in a form of an MLP. The function F_{θ} may be implemented in a form of, for example, a sparse voxel grid that is represented with volume densities and coefficients of spherical harmonics representing colors.

In the process of S506, based on the output from the above-described model, the training unit 206 first calculates, for each of the learning background colors set in S504, pixel values of a virtual viewpoint image the virtual viewpoint of which is the same as the image capturing viewpoint for performing image capturing of each of the captured images obtained in S501. In the following description, the virtual viewpoint image will be referred to as an “estimated image.” The training unit 206 then optimizes the parameters of the MLP such that the pixel values of the estimated image calculated for each of the learning background colors approach the pixel values of corresponding one of the training images generated in S505. Specifically, taking Loss in Equation (3) as a loss, the training unit 206 trains the above-described model by iterating the process of calculating the loss and updating the parameters of the MLP by back propagation.

$$Loss = {\sum }_{k = 1}^{K} {\sum }_{r ∈ R} {‖ {c}_{PREDk} ( r ) - {c}_{GTk} ( r ) ‖}_{2}^{2} \qquad Equation ( 3 )$$

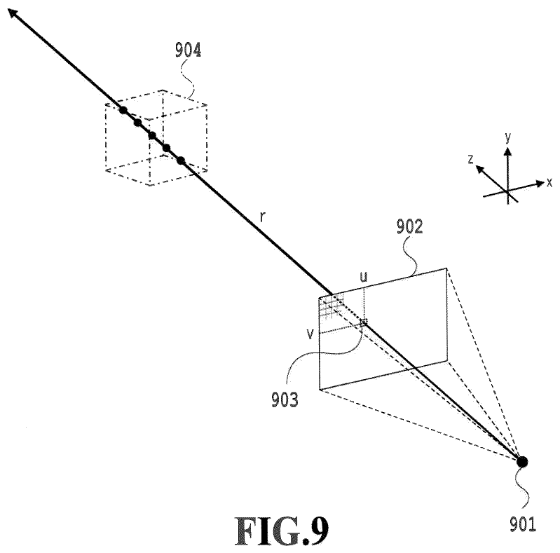

Here, r denotes a ray determined based on the position (u, v) of each pixel of the captured image and the camera parameters obtained in S501, and R denotes a set of rays corresponding to pixels sampled from all the captured images constituting the multi-viewpoint images. FIG. 9 is a diagram illustrating an example of a ray r according to the first embodiment. FIG. 9 schematically illustrates the positional relationship among the ray r, a position 901 of an image capturing device 310, an image plane 902, a pixel 903 corresponding to the ray r, and a region to be learned 904. In Equation (3), c_{PREDk}(r) is the RGB value of a pixel of an estimated image corresponding to the ray r that is calculated for the background color k. In Equation (3), c_{GTk}(r) is the RGB value of a pixel of a training image for the background color k corresponding to the ray r. That is, the loss obtained from Equation (3) indicates the sum total, over all the learning background colors, of the difference between the estimated image and the training image calculated for each learning background color. In more detail, the RGB value c_{PREDk}(r) of the estimated image is calculated based on the output of the above-described model and the RGB value of the background color k using, for example, Equations (4) to (7).

$${c}_{PREDk} ( r ) - {c}_{VR} ( r ) + ( 1 - {α}_{VR} ( r ) ) {c}_{BGk} ( r ) \qquad Equation ( 4 )$$

$${c}_{VR} ( r ) = {\sum }_{i = 1}^{N} {T}_{i} ( 1 - exp ( - {σ}_{i} {δ}_{i} ) ) {c}_{i} \qquad Equation ( 5 )$$

$${α}_{VR} ( r ) = {\sum }_{i = 1}^{N} {T}_{i} ( 1 - exp ( - {σ}_{i} {δ}_{i} ) ) \qquad Equation ( 6 )$$

$${T}_{i} = exp ( - {\sum }_{j = 1}^{i - 1} {σ}_{j} {δ}_{i} ) \qquad Equation ( 7 )$$

Here, i denotes an index of one of sampling points arranged on the ray r in the region to be learned, and N denotes the number of the sampling points. cᵢ and σᵢ denote an RGB value and a volume density output from the above-described model for the i-th sampling point, respectively. δi denotes the distance from the i-th sampling point to the (i+1)-th sampling point. In Equations (4) to (7), c_{VR}(r) and α_{VR} (r) denote, respectively, an RGB value as an integrated value of colors and an opacity that are obtained by performing volume rendering on the ray r based on the above-described model. Tᵢ denotes an accumulated transmittance from the position of the image capturing device 310 to the sampling point. In the following description, an estimated image calculated for the background color k will be referred to as an “estimated image for the background color k.”

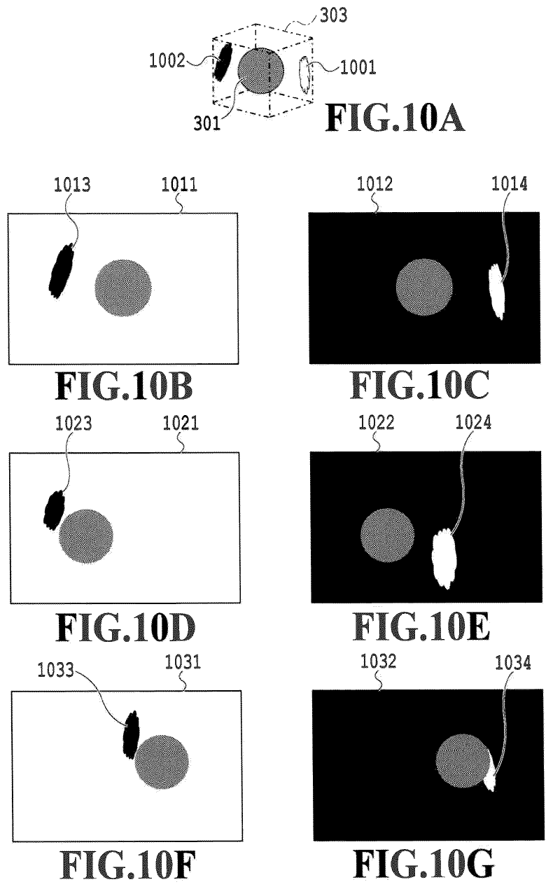

FIGS. 10A to 10G are diagrams illustrating objects represented with erroneous radiance fields and examples of an estimated image calculated based on the erroneous radiance fields. Specifically, FIG. 10A illustrates an example of the objects represented with the erroneous radiance fields. The objects include the object 301 being a target actually present in the region to be learned 303 and objects 1001 and 1002 that are not actually present. FIG. 10B illustrates an example of an estimated image 1011 corresponding to the captured image 410 in FIG. 4A in a case of the background color 1. FIG. 10C illustrates an example of an estimated image 1012 corresponding to the captured image 410 in FIG. 4A in a case of the background color 2. FIG. 10D illustrates an example of an estimated image 1021 corresponding to the captured image 420 in FIG. 4B in a case of the background color 1. FIG. 10E illustrates an example of an estimated image 1022 corresponding to the captured image 420 in FIG. 4B in a case of the background color 2. FIG. 10F illustrates an example of an estimated image 1031 corresponding to the captured image 430 in FIG. 4C in a case of the background color 1. FIG. 10G illustrates an example of an estimated image 1032 corresponding to the captured image 430 in FIG. 4C in a case of the background color 2.

As illustrated in FIGS. 10B, 10D, and 10F, representations 1013, 1023, and 1033 of the object 1002 of a color close to black, which is the background color 2, are included in white regions, which are the transmissive region in the estimated images 1011, 1021, and 1031 for the background color 1, respectively. In such a case, there are significant differences in pixel values between the estimated images 1011, 1021, and 1031 and the training images 811, 821, and 831 for the background color 1 illustrated in FIGS. 8A, 8C, and 8E, which exclude the representations 1013, 1023, and 1033, respectively. As illustrated in FIGS. 10C, 10E, and 10G, representations 1014, 1024, and 1034 of the object 1001 of a color close to white, which is the background color 1, are included in black regions, which are the transmissive region in the estimated images 1012, 1022, and 1032 for the background color 2, respectively. In such a case, there are significant differences in pixel values between the estimated images 1012, 1022, and 1032 and the training images 812, 822, and 832 for the background color 2 illustrated in FIGS. 8B, 8D, and 8F, which exclude the representations 1014, 1024, and 1034, respectively.

That is, in a case where the space represented with the radiance fields includes an object that is not actually present, a difference in pixel values between an estimated image and a training image becomes significant in any one of the plurality of learning background colors, increasing the value of the loss in Equation (3). Accordingly, performing the training such that the loss in Equation (3) is decreased makes the above-described model less likely to converge to an erroneous state. As a result, it is possible to estimate correct radiance fields, that is, such radiance fields that show no object not actually present in the space corresponding to the transmissive region, with high accuracy.

After S506, in S507, the output unit 207 outputs difference information indicating a difference between the estimated image obtained by the volume rendering based on the radiance fields estimated in S506 and the training image used in the estimation of the radiance fields. Specifically, for example, the output unit 207 outputs a signal indicating the difference information to the display device 112 to cause the display device 112 to display the difference information.

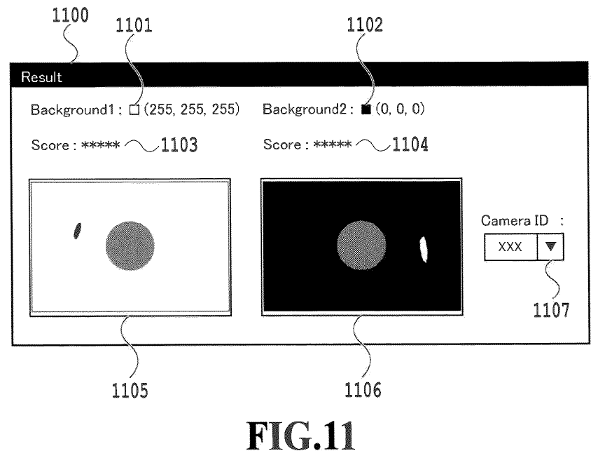

FIG. 11 is a diagram illustrating an example of a GUI 1100 that the output unit 207 causes the display device 112 to display, according to the first embodiment. The GUI 1100 illustrated in FIG. 11 as an example includes background color display fields 1101 and 1102, background color score display fields 1103 and 1104, background color image display regions 1105 and 1106, and a camera ID setting field 1107. The background color display fields 1101 and 1102 are fields that display information about the learning background colors used for the estimation of the radiance fields in S506. The background color score display fields 1103 and 1104 are fields that display information (the difference information) indicating the difference between the training image and the estimated image, which is calculated for each learning background color. The background color score display fields 1103 and 1104 display, as the difference information, for example, a value indicating the magnitude of the mean square error of pixel values.

The camera ID setting field 1107 is a user interface (UI) component for selecting an image capturing device desired by the user from among the plurality of image capturing devices 310. The background color image display regions 1105 and 1106 are regions that display estimated images from a virtual viewpoint corresponding to the image capturing viewpoint of the image capturing device 310 selected by the user via the camera ID setting field 1107 and are regions that display the estimated images with learning background colors different from each other. The display method for the content of the displayed difference information and the difference information is not limited to the above-described example. For example, the information processing apparatus 100 generate the difference image illustrating the difference between the training image and the estimated image for each learning background color, and may display the difference image or display the difference image together with at least one of the training image and the estimated image side by side. The information processing apparatus 100 may display the difference information at any time in the course of the training process in S506. Such displaying enables the user to easily grasp, based on the displayed difference information, whether an object not actually present is included in the space represented with the radiance fields.

After S507, in S508, the output unit 207 outputs information about the radiance fields estimated in S506 to cause the storage device 111 to store the information, for example. The destination of the output of the information about the radiance fields is not limited to the storage device 111. For example, the output unit 207 may output the information to an external apparatus other than the information processing apparatus 100. After S508, the information processing apparatus 100 finishes the processes in the flowchart illustrated in FIG. 5.

The information processing apparatus 100 configured as described above can estimate the radiance fields in the region to be learned with high accuracy. As a result, it is possible to inhibit an artifact that appears on a virtual viewpoint image obtained by the rendering using the radiance fields.

Although the present embodiment is described with a case where the captured images are RGB images, as an example, the captured images may be images in another format such as gray-scale images, XYZ images, or YUV images.

Although the present embodiment is described with a case where the background color setting unit 204 sets the two colors including white and black in S504 as the learning background colors, as an example, the background color setting unit 204 may set two or more other colors as the learning background colors. More suitably, the background color setting unit 204 desirably sets, to the learning background colors, a plurality of colors that maximizes the sum total or minimum value of the distances among them in a color space used to calculate the loss, that is, a color space in which the training image and the estimated image are represented. In this case, in a case where an object that has a color close to any one of the learning background colors and is not actually present is included in the space represented with the radiance fields, the difference between the estimated image and the training image based on the other learning background colors becomes more significant. As a result, the convergence to erroneous radiance fields becomes less unlikely to occur.

The background color setting unit 204 may set a plurality of learning background colors different from one another for each pixel position or each captured image. For example, the background color setting unit 204 may set the color of each pixel of the above-described background image to one of the plurality of learning background colors. In this case, the training unit 206 can directly use the captured image as part of a training image.

The background color setting unit 204 may set a different number of learning background colors for each pixel position or each captured image. For example, the background color setting unit 204 may set a plurality of learning background colors for pixels of the transmissive region as described above and may set the color of each pixel of the background image for pixels of the object region as a learning background color. In this case, for the transmissive region, the information processing apparatus 100 can estimate, with high accuracy, the radiance fields of a region to be learned including a translucent object allowing background colors to show through while inhibiting an object not actually present from appearing. In a case where, for example, it is known that a region to be learned includes an opaque object, the background color setting unit 204 may set colors that are significantly different from the colors of pixels of a captured image, such as complementary colors of the colors of the pixels, as the learning background colors for pixels of the object region. In this case, in a case where the object represented with the radiance fields is translucent or transparent, the difference between the training image and the estimated image increases. As a result, the information processing apparatus 100 can inhibit the object represented with the estimated radiance fields from being erroneously made translucent or erroneously made partially disappear.

### Second Embodiment

In the first embodiment, an aspect in which the plurality of set learning background colors are all used in every iteration of the calculation of the loss in the training has been described. In the present embodiment, an aspect in which a different learning background color is used in each iteration of the calculation of the loss in the training will be described.

The hardware configuration and the logical configuration of an information processing apparatus 100 according to the present embodiment and the general processing flow to be executed by the information processing apparatus 100 are the same as those of the information processing apparatus 100 according to the first embodiment. Note that the information processing apparatus 100 according to the present embodiment differs from the information processing apparatus 100 according to the first embodiment in how to calculate the loss in S506. The following will mainly describe differences between the present embodiment and the first embodiment. In the description, identical components as those in the first embodiment will be denoted by identical reference characters.

In each iteration of the calculation of the loss in the training, the training unit 206 according to the present embodiment selects one background color kₜ from among the plurality of set learning background colors and calculates, for example, a loss denoted as Loss' using Equation (8).

$${Loss}^{′} = {\sum }_{r ∈ R} {‖ {c}_{{PREDk}_{t}} ( r ) - {c}_{{GTk}_{t}} ( r ) ‖}_{2}^{2} \qquad Equation ( 8 )$$

Here, c_{PREDkt}(r) denotes RGB values of an estimated image generated using the background color kₜ, and c_{GTkt}(r) denotes RGB values of a training image generated using the background color kₜ. The loss' calculated using Equation (8) represents the difference between the estimated image and the training image for the learning background color kₜ.

The training unit 206 selects the background color kₜ for each iteration such that the learning background colors are evenly selected through the iterations of the calculation of the loss in the training. For example, in a case where the learning background colors are two colors including white and black, the training unit 206 is only required to select white for odd iterations and select black for even iterations as the background color kₜ. The training unit 206 may select the background color kₜ from among the plurality of learning background colors at random in each iteration based on a table of random numbers or the like. For example, in a case where the loss' is calculated for only the selected background color kₜ using Equation (8), the amount of computation and a required amount of memory are reduced compared with the case where the loss is calculated for all the learning background colors using Equation (3).

With the information processing apparatus 100 configured as described above, it is possible to estimate the radiance fields in the region to be learned with high accuracy while reducing the amount of computation and the amount of memory needed to calculate the loss in each iteration more than the information processing apparatus 100 according to the first embodiment.

Note that although the aspect in which the training unit 206 selects one learning background color from among the plurality of learning background colors to be used in the process of calculating the loss has been described in the present embodiment, the training unit 206 may select two or more colors from among the plurality of learning background colors to be used in the process of calculating the loss. The number of learning background colors to be used for the process of calculating the loss may differ in each iteration of the process of the calculation. For example, in a case where the training unit 206 uses the two or more selected learning background colors to be used in the process of calculating the loss, the training unit 206 is only required to calculate, as the loss, the sum total of the differences between the estimated image and the training image for the selected learning background colors using, for example, Equation (3).

### OTHER EMBODIMENTS

In the above-mentioned embodiments, the aspects in which the volume densities for the positions and the radiance fields representing colors for the directions are estimated as the spatial information have been described. Information represented by the spatial information is not limited to the radiance fields. For example, the spatial information may represent the volume densities for the positions and colors irrespective of directions or may represent colors for the positions and Signed Distance Fields representing the distances between the positions and the surface of the object. The technique according to the present disclosure is applicable to various methods that determine the pixel values of an estimated image based on colors represented with spatial information and of opacities, such as Gaussian Splatting.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

With the technique according to the present disclosure, it is possible to estimate spatial information on a region to be learned with high accuracy.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-177813, filed Oct. 10, 2024, which is hereby incorporated by reference herein in its entirety.

What is claimed is:

1. An information processing apparatus comprising:
one or more hardware processors; and
one or more memories storing one or more programs configured to be executed by the one or more hardware processors, the one or more programs including instructions for:
obtaining a plurality of captured images and camera parameters, the plurality of captured images being obtained by performing image capturing on an object from a plurality of viewpoints, the camera parameters corresponding to each of the plurality of viewpoints in the image capturing;
obtaining information indicating a transmissive region in each of the plurality of captured images;
setting a plurality of background colors different from one another;
generating training images corresponding to each of the plurality of background colors based on the captured images and the transmissive region; and
learning spatial information based on differences between color values of synthesized colors and color values of the training image corresponding to each background color of the plurality of background colors, the synthesized colors each being obtained by synthesizing, for each of the background colors, an accumulated color and the background color, the accumulated color being obtained by accumulating pieces of the spatial information based on the camera parameters.

2. The information processing apparatus according to claim 1, wherein the one or more programs further include instructions for
outputting information about the difference for each of the background colors.

3. The information processing apparatus according to claim 1, wherein the one or more programs further include instructions for
learning the spatial information such that a sum total of the differences for each of the background colors becomes smaller.

4. The information processing apparatus according to claim 1, wherein the one or more programs further include instructions for
iterating a process of calculating the difference between the color values of the synthesized colors and the color values of the training image, and selecting the background color to be used for the process of calculating the difference from among the plurality of background colors for each iteration of the process of calculating the difference.

5. The information processing apparatus according to claim 1, wherein the one or more programs further include instructions for
setting, as the plurality of background colors, a plurality of colors such that distances between the plurality of colors in a color space are long.

6. The information processing apparatus according to claim 5, wherein the one or more programs further include instructions for
setting, as the plurality of background colors, a plurality of colors such that distances between the plurality of colors in the color space are maximized.

7. The information processing apparatus according to claim 1, wherein the one or more programs further include instructions for
setting, as one of the plurality of background colors, a color of a background image obtained by performing image capturing in a state where the object is not present in a region to be learned that is set in a space where the object is present.

8. The information processing apparatus according to claim 1, wherein the one or more programs further include instructions for
setting, as one of the plurality of background colors, a color different from a color of the captured image.

9. An information processing method comprising the steps of:
obtaining a plurality of captured images and camera parameters, the plurality of captured images being obtained by performing image capturing on an object from a plurality of viewpoints, the camera parameters corresponding to each of the plurality of viewpoints in the image capturing;
obtaining information indicating a transmissive region in each of the plurality of captured images;
setting a plurality of background colors different from one another;
generating training images corresponding to each of the plurality of background colors based on the captured images and the transmissive region; and
learning spatial information based on differences between color values of synthesized colors and color values of the training image corresponding to each background color of the plurality of background colors, the synthesized colors each being obtained by synthesizing, for each of the background colors, an accumulated color and the background color, the accumulated color being obtained by accumulating pieces of the spatial information based on the camera parameters.

10. A non-transitory computer readable storage medium storing a program for causing a computer to perform a control method of an information processing apparatus, the control method comprising the steps of:
obtaining a plurality of captured images and camera parameters, the plurality of captured images being obtained by performing image capturing on an object from a plurality of viewpoints, the camera parameters corresponding to each of the plurality of viewpoints in the image capturing;
obtaining information indicating a transmissive region in each of the plurality of captured images;
setting a plurality of background colors different from one another;
generating training images corresponding to each of the plurality of background colors based on the captured images and the transmissive region; and
learning spatial information based on differences between color values of synthesized colors and color values of the training image corresponding to each background color of the plurality of background colors, the synthesized colors each being obtained by synthesizing, for each of the background colors, an accumulated color and the background color, the accumulated color being obtained by accumulating pieces of the spatial information based on the camera parameters.
